(19) United States
(12) Patent Application Publication
(10) Pub. No.: US 2006/0023594 A1
(43) Pub. Date: Feb. 2, 2006

(54) Evaluation disc

(75) Inventors: Teruaki Sogawa, Osaka (JP); Joji Yoshioka, Osaka (JP); Katsuichi Inoue, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/188,741

(22) Filed: Jul. 26, 2005

(30) Foreign Application Priority Data
Jul. 27, 2004 (JP) P. 2004-218107

(51) Int. Cl. G11B 7/00

(52) U.S. Cl. 369/53.1; 369/44.11; 369/275.1

(57) ABSTRACT

An evaluation disc for use in evaluating a pickup head of an optical disc device, including: an inner circular region: an intermediate circular region; and an outer circular region; wherein the outer circular region and the intermediate circular region are formed on the outer side of the inner circular region; the outer circular region is formed on the outer side of the intermediate circular region; each of the inner circular region, the intermediate circular region and the outer circular region being divided in to a CD evaluation region written with CD standard recording information and a DVD evaluation region written with DVD standard recording information.

### BACKGROUND OF THE INVENTION

1. Field of the Invention

The present invention relates to an evaluation disc for use in regulating and evaluating an optical disc device operable of performing recording/reproducing operation for both a CD standard optical disc and a DVD standard optical disc.

2. Description of the Related Art

An optical disc device (multi-purpose optical disc device) operable of performing recording/reproducing operation for both a CD standard optical disc and a DVD standard optical disc has been used popularly. It is well known that, although a CD and a DVD have the same outer configuration (diameter of 12 cm and thickness of 1.2 mm), standards of information to be recorded (recording information) for the CD and the DVD are different in, such as thickness to a recording layer, reflectivity at the recording layer and physical amount of recording bits, etc. Therefore, in fabricating the multi-purpose optical disc device, tests for confirming performance thereof, which are related to recording/reproduction of CD standard information and DVD standard information, are performed and the multi-purpose optical disc device is evaluated for CD and DVD on the basis of results of the tests. It is conventional that, in evaluating the performance of the optical disc device, etc., a disc of such as glass, which has an outer configuration and a size identical to those of the CD as well as the DVD and has no side run out and/or warp, is used as an evaluation disc. In concrete, the evaluation disc is set in the optical disc device, performance of which is to be evaluated, and a test is performed for every test item by executing an evaluation program stored in the optical disc device and the recording/reproducing performance of the optical disc device are evaluated on the basis of results of the test. The test items are related mainly to performance of a pickup head of the optical disc device.

In a case where the optical disc device to be tested is a multi-purpose optical disc device, it is necessary to test the optical disc device on test items for both the CD and the DVD. On the other hand, in a case where an evaluation disc for evaluating the CD and an evaluation disc for evaluating the DVD are different, it is necessary to perform an exchange of one of the evaluation discs of CD and DVD to the other in setting it the optical disc device. Such exchange of evaluation disc requires additional labor and time for evaluation of the optical disc device.

In view of this fact, an evaluation disc capable of testing and evaluating the optical disc device for both CD and DVD was proposed in JP-A-2002-15477, which is given below. The proposed evaluation disc has an inner circular side portion in which CD standard data is written and an outer circular side portion in which DVD standard data is written.

However, since the evaluation disc proposed in JP-A-2002-15477 is constructed in such a way that CD standard data is written in the inner circular side thereof and DVD standard data is written in the outer circular side as mentioned above, there is a problem that a test of difference in phase between side beams, etc., can not be performed appropriately. In concrete, since a radius of a track formed in an optical disc increases with increase of distance of the track measured from a center of the optical disc and a tilt of a tangential line depends upon a radial position of the track of the optical disc, the side beam phase difference is changed depending upon the radial position of the optical disc. In the evaluation disc proposed in JP-A-2002-15477, the test for measuring the side beam phase difference in the outer circular side portion of the evaluation disc can not be performed since CD standard data is written in the inner circular side portion of the evaluation disc for CD. On the other hand, in the evaluation for DVD, the test for measuring the side beam phase difference can not be performed since the DVD standard data is written in the outer circular side portion of the evaluation disc. As a result, the measurement of side beam phase differences in the inner and outer circular side portions for CD and DVD can not be done, so that there is a problem that the test of the side beam phase difference can not be performed appropriately.

Further, no land pre-pit (LPP) is formed in an area of the conventional evaluation disc in which DVD standard data is written and, therefore, tests related to leak-in of the LPP in a reproducing signal can not be performed.

### SUMMARY OF THE INVENTION

An object of the present invention is to provide an evaluation disc for appropriately evaluating performance of an optical disc device capable of performing recording/reproducing operation for both a CD standard optical disc and a DVD standard optical disc.

An evaluation disc according to the present invention has the following constructive features for solving the above problems.

According to a first aspect of the invention, there is provided an evaluation disc for use in evaluating a pickup head of an optical disc device, including: an inner circular region: an intermediate circular region; and an outer circular region; wherein the outer circular region and the intermediate circular region are formed on the outer side of the inner circular region; the outer circular region is formed on the outer side of the intermediate circular region; each of the inner circular region, the intermediate circular region and the outer circular region being divided in to a CD evaluation region written with CD standard recording information and a DVD evaluation region written with DVD standard recording information.

In this construction of the evaluation disc in which the CD evaluation region having the CD standard recording information written therein and the DVD evaluation region having the DVD standard recording information written therein are formed in each of the inner circular region, the intermediate circular region and the outer circular region, it is possible to measure the side beam phase difference, etc., in the inner, intermediate and outer circular regions for a CD and a DVD. Therefore, it is possible to measure the side beam phase difference for CD and DVD in an inner side and an outer side of the CD and the DVD to thereby appropriately evaluate characteristics of the optical disc device on the basis of results of the measurements.

According to a second aspect of the invention, at least one of the DVD evaluation regions includes a land pre-pit region formed with a land pre-pit.

In such construction of the evaluation disc, it is also possible to perform an evaluation related to leak-in of the land pre-pit (LPP) in a reproducing signal.

According to a third aspect of the invention, at least one of the DVD evaluation regions has a pit different in depth than that of the other of the DVD evaluation regions.

In such construction of the evaluation disc, it is possible, in the DVD test, to make a level of a tracking error signal obtained by the DPP (Differential Push-Pull) method sufficient, so that it is possible to appropriately perform an evaluation related to the tracking error.

Incidentally, in a general optical disc device having a recording function for DVD, the tracking error signal is generated by the DPP method.

Since, according to the present invention, the CD evaluation region in which CD standard recording information is written and the DVD evaluation region in which DVD standard recording information is written are provided in each of the inner circular region, the intermediate circular region and the outer circular region of the evaluation disc, which are divided in radial direction of the evaluation disc, it is possible to measure the side beam phase difference, etc., in the inner, intermediate and outer circular regions for a CD and a DVD. Therefore, it is possible to measure the side beam phase difference on the inner and outer circular sides for CD and DVD to thereby appropriately evaluate characteristics of the optical disc device on the basis of results of measurements.

It is also possible to perform an evaluation related to the leak-in of land pre-pit (LPP) in the reproducing signal.

### BRIEF DESCRIPTION OF THE DRAWINGS

These and other objects and advantages of this invention will become more fully apparent from the following detailed description taken with the accompanying drawings in which:

FIG. 1 schematically shows a construction of a main portion of an optical disc device the performance of which is to be evaluated;

FIG. 2 shows an evaluation disc according to an embodiment of the present invention; and

FIG. 3 is a flowchart showing an evaluation processing in the optical disc device.

### DETAILED DESCRIPTION OF THE PREFERRED EMBODIMENTS

An embodiment of the evaluation disc according to the present invention will be described below.

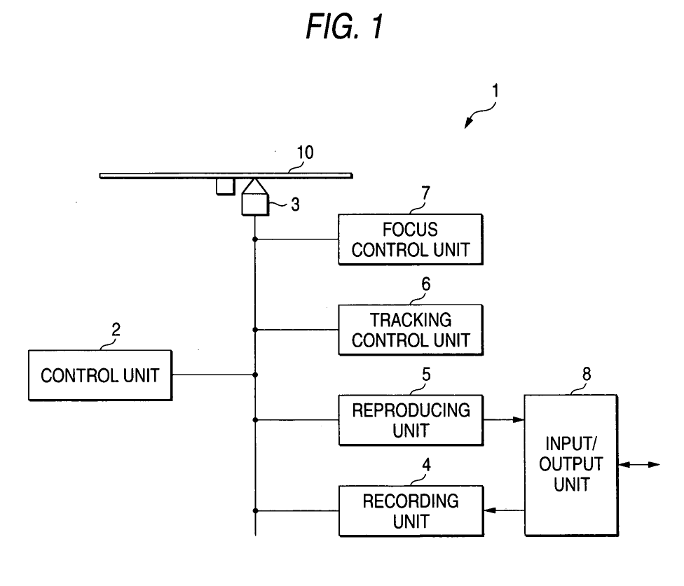

An optical disc device whose characteristics are to be evaluated by using the evaluation disc according to the present invention will be briefly described first. FIG. 1 shows a construction of a main portion of the optical disc device schematically. The optical disc device 1 is a multi-purpose optical disc device, which can perform recording/reproducing for two kinds of optical disc, a CD and a DVD. The multi-purpose optical disc device 1 includes a control unit 2 for controlling an operation of the body of the device, a pickup head 3 for irradiating an optical disc 10 (either CD or DVD) set in the device 1 with laser light during data recording and reproducing operations, a recording unit 4 for controlling, during the data recording operation, the laser light irradiation on the basis of the data to be recorded in the optical disc 10, a reproducing unit 5 for generating, during the reproducing operation, a reproducting signal by processing an RF signal from the pickup head 3, a tracking control unit 6 for performing a tracking servo control on the basis of a tracking error signal (TE signal) obtainable from the pickup head 3, a focus control unit 7 for performing a focus servo control on the basis of a focus error signal (FE signal) obtainable from the pickup head 3 and an input/output unit 8 for receiving data to be recorded in the optical disc 10 and outputting a reproducing signal obtained by reproducing the data recorded in the optical disc 10.

The pickup head 3 includes a first light source for generating laser light (wavelength being 780 nm) for irradiating a CD, a first light receiving element for detecting reflection light from the CD, a second light source for generating laser light (wavelength being 650 nm) for irradiating a DVD, a second light receiving element for detecting reflection light from the DVD, an objective lens for condensing laser light to be irradiated to the optical disc and a two-axle actuator for moving the objective lens in radial directions of the optical disc 10, and to or away from the optical disc 10 etc. Further, the pickup head 3 is mounted on the device movably in the radial direction of the optical disc 10 by a thread motor, which is not shown.

Incidentally, the first and second light receiving elements may be constructed integrally.

The recording unit 4 performs an encoding of the data, which is inputted to the input/output unit 8 and is to be recorded in the optical disc 10, and a power control of the laser light to be irradiated to the optical disc 10 from the pickup head 3, on the basis of the data encoded, etc. The reproducing unit 5 obtains the data recorded in the optical disc 10 from the RF signal obtained from the pickup head 3 and generates the reproducing signal obtained by decoding the data, etc. The reproducing signal generated by the reproducing unit 5 is externally outputted through the input/output unit 8. The tracking control unit 6 performs the servo control (tracking control) for adjusting an irradiating position of laser light to the track of the optical disc 10 by moving the pickup head 3 and the objective lens provided in the pickup head 3 in the radial direction of the optical disc 10 on the basis of the TE signal from the pickup head 3. The optical disc device 1 performs the tracking control by using the DPP method. The focus control unit 7 performs the servo control (focus control) for adjusting a condensing position of the laser light to a data recording plane of the optical disc 10 by moving the objective lens provided in the pickup head 3 forward and backward with respect to the optical disc 10 on the basis of the TE signal from the pickup head 3.

Further, the control unit 2 stores an evaluation program for performing the test of every test item by using the evaluation disc according to the embodiment of the present invention and executing the evaluation processing for every test item on the basis of result of the tests. The evaluation program evaluates the performance of the pickup head 3 by mainly measuring the test items related to the performance of the pickup head 3.

Incidentally, since the recording processing related to the data recording to the optical disc 10 and the reproduction processing for reproducing the data recorded in the optical disc 10 in the optical disc device 1 are the same as those in any known device, detailed description thereof is omitted.

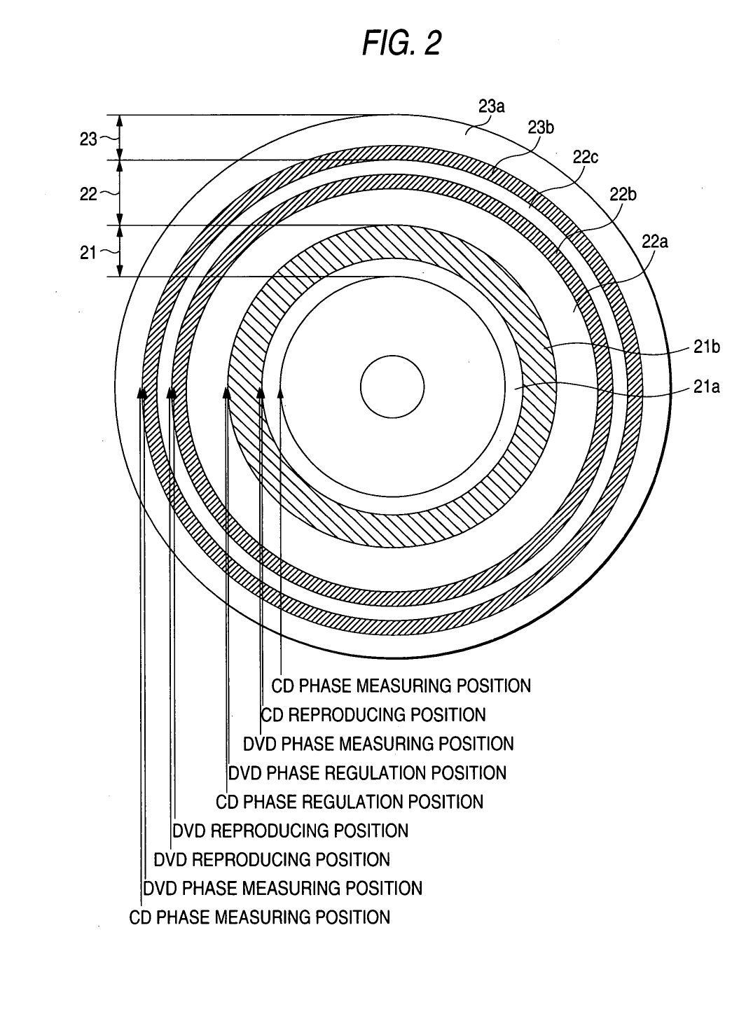

FIG. 2 shows an evaluation disc 20 according to an embodiment of the present invention. The evaluation disc 20 has an outer configuration identical to a CD as well as a DVD, whose diameter and thickness are 12 cm and 1.2 mm, respectively. The evaluation disc 20 is made of glass or polycarbonate. As shown in FIG. 2, the evaluation disc is divided in radial direction in to an inner circular region 21, an intermediate circular region 22 and an outer circular region 23. The area of the inner circular region 21 is defined in a range from 25 mm to 36 mm measured from a center of the evaluation disc 20. The area of the intermediate circular region 22 is defined in a range from 36 mm to 50 mm measured from the center of the evaluation disc 20 and the area of the outer circular region 23 is defined in a range from 50 mm to 60 mm measured from the center of the evaluation disc 20. The inner circular region 21 is divided in radial direction of the disc in to an inner CD evaluation region 21a recorded with CD standard information and an inner DVD evaluation region 21b recorded with DVD standard information. The inner CD evaluation region 21a is defined in a range from 25 mm to 29.3 mm measured from the center of the evaluation disc 20 and the inner DVD evaluation region 21b is defined in a range from 29.3 mm to 36 mm measured from the center of the evaluation disc 20. In the inner CD evaluation region 21a, the CD standard recording information is written and the depth of the pit is λ/4. In the inner DVD evaluation region 21b, the DVD standard recording information is written and the depth of the pit is λ/8.

Further, the intermediate circular region 22 is divided in to an intermediate CD evaluation region 22a written with the CD standard recording information, a first intermediate DVD evaluation region 22b written with the DVD standard recording information and a second intermediate DVD evaluation region 22c written with the DVD standard recording information. In the intermediate CD evaluation region 22a, the CD standard recording information is formed and depth of the pit therein is λ/4. In the first intermediate DVD evaluation region 22b, the DVD standard recording information is formed and depth of the pit therein is λ/4. Further, in the second intermediate DVD evaluation region 22c, the DVD standard recording information and the land pre-pits are formed. The pit depth of the recording information and the land pre-pit is λ/4, respectively.

Further, the outer circular region 23 is divided in to an outer DVD evaluation region 23b written with DVD standard recording information and an outer CD evaluation region 23a written with CD standard recording information. The outer DVD evaluation region 23b is defined in an area ranging from 50 mm to 53.7 mm measured from the center of the evaluation disc 20 and the outer CD evaluation region 23a is defined in an area ranging from 53.7 mm to 60 mm measured from the center of the evaluation disc 20. In the outer CD evaluation region 23a, the CD standard recording information is formed and the depth of the pit therein is λ/4. In the outer DVD evaluation region 23b, the DVD standard recording information is formed and the depth of the pit is λ/8.

The test disc 20 is fabricated by forming, for example, the following members and laminating them with centers thereof being unified.

A. a member having an inner radius of 7.5 mm and an outer radius of 29.3 mm, in which the inner CD evaluation region 21a is formed,

B. a member having an inner radius of 29.3 mm and an outer radius of 36 mm, in which the inner DVD evaluation region 21b is formed,

C. a member having an inner radius of 36 mm and an outer radius of 43 mm, in which the intermediate CD evaluation region 22a is formed,

D. a member having an inner radius of 43 mm and an outer radius of 47 mm, in which the first intermediate DVD evaluation region 22b is formed,

E. a member having an inner radius of 47 mm and an outer radius of 50 mm, in which the second intermediate DVD evaluation region 22c is formed,

F. a member having an inner radius of 50 mm and an outer radius of 53 mm, in which the outer DVD evaluation region 23b is formed, and

G. a member having an inner radius of 53 mm and an outer radius of 60 mm, in which the outer CD evaluation region 23a is formed.

The members D and E may be formed integrally.

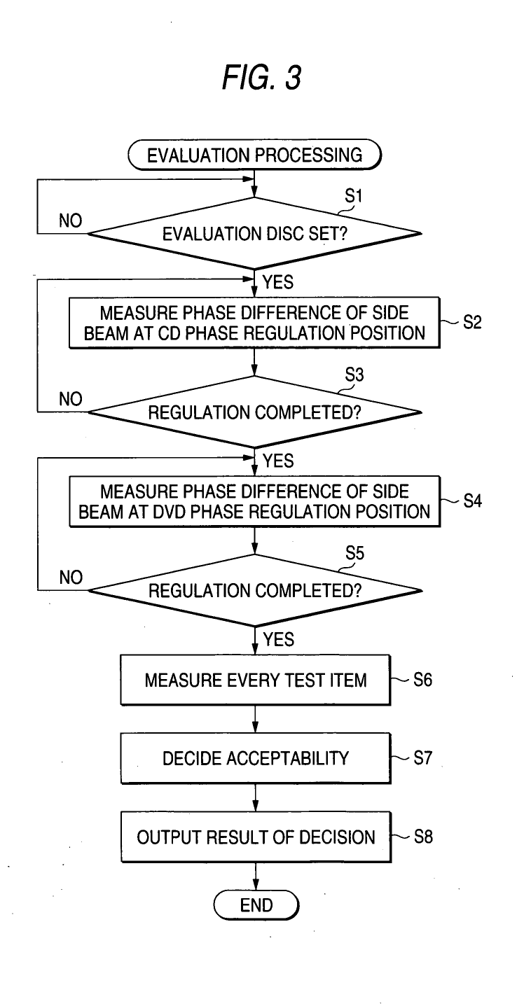

An evaluation operation for evaluating the performance of the optical disc device 1 with using the evaluation disc 20 according to this embodiment will be described. FIG. 3 is a flowchart showing an evaluation processing for the optical disc device to be evaluated. In the optical disc device 1 to be evaluated, the evaluation program stored in the control unit 2 is executed. Upon the execution of the evaluation program, the optical disc device 1 starts the evaluation processing shown in FIG. 3.

The optical disc device 1 waits for an insertion of the evaluation disc 20 into a body thereof (s1) and, when the evaluation disc 20 is inserted, the phase difference of side beams is measured by irradiating a certain position (CD phase regulation position) of the evaluation disc 20, which is 36.5 mm measured from the center of the evaluation disc 20, with laser light emitted from the first CD light source provided in the pickup head 3 (s2). In this case, an operator regulates the mounting position of the optical parts provided in the pickup head 3 in such a way that a side beam phase difference for CD is minimized. When the regulation related to the side beam phase difference for CD is completed by, for example, inputting information of the completion of the regulation related to the side beam phase difference for CD to the optical disc device (s3), the optical disc device 1 measures the side beam phase difference by irradiating a position (DVD phase regulation position) of the evaluation disc 20, which is at a distance of 35.5 mm measured from the center of the evaluation disc 20, with laser light emitted from the first DVD light source provided in the pickup head 3 (s4). In this case, the operator regulates the mounting position of the optical parts provided in the pickup head 3 in such a way that the side beam phase difference is minimized. When the optical disc device 1 completes the regulation related to the side beam phase difference for DVD by, for example, inputting an information of the completion of the regulation related to phase difference for DVD to the optical disc device 1 by the operator (s5), the optical disc device 1 performs measurements for respective test items 1 to 7 to be described later (s6).

The CD phase regulation position and the DVD phase regulation position are the positions where it is experimentally confirmed that an amount of deviation (absolute value) between the phase difference in the innermost circle of the optical disc 20 and the phase difference in the outermost circle of the optical disc 10 is minimized. The CD phase regulation position is located in the inner CD evaluation region 22a and the DVD phase regulation position is located in the inner DVD evaluation region 21b. Further, since the depth of the DVD standard recording information pit in the inner DVD evaluation region 21b is λ/8, it is possible to obtain the TE signal of sufficient level by DPP method. Therefore, it is possible to appropriately perform the regulation related to side beam phase difference for DVD.

In the step s6, the optical disc device 1 performs the following measurements:

1—measurement of the side beam phase difference on the inner circle side for CD by irradiating the position (inner CD evaluation region 21a) of the optical disc, which is 25 mm measured from the center of the evaluation disc 20, with laser beam from the first CD light source provided in the pickup head 3.

2—measurement of level of the reproducing signal (RF signal) for CD by irradiating the position (inner CD evaluation region 21a) of the optical disc, which is 29 mm measured from the center of the evaluation disc 20, with laser beam from the first CD light source provided in the pickup head 3.

3—measurement of the side beam phase difference on the inner circle side for DVD by irradiating the position (inner DVD evaluation region 21b) of the optical disc, which is 29.3 mm measured from the center of the evaluation disc 20, with laser beam from the first DVD light source provided in the pickup head 3.

4—measurement of level of the reproducing signal (RF signal) for DVD by irradiating the position (first intermediate DVD evaluation region 22c) of the optical disc, which is 45 mm measured from the center of the evaluation 20, with laser beam from the first DVD light source provided in the pickup head 3.

5—measurement of level of the reproducing signal (RF signal) for DVD by irradiating the position (second intermediate DVD evaluation region 22c) of the optical disc, which is 48 mm measured from the center of the evaluation disc 20, with laser beam from the first DVD light source provided in the pickup head 3.

6—measurement of the side beam phase difference on the outer circle side for DVD by irradiating the position (outer DVD evaluation region 23b) of the optical disc, which is 53.5 mm measured from the center of the evaluation 20, with laser beam from the first DVD light source provided in the pickup head 3.

7—measurement of the side beam phase difference on the outer circle side for CD by irradiating the position (outer CD evaluation region 23a) of the optical disc, which is 54 mm measured from the center of the evaluation disc 20, with laser beam from the first CD light source provided in the pickup head 3.

When the measurements for all test items in the step s6 are completed, it is determined according to the results of the tests whether or not the performance of the optical disc device 1 is acceptable (s7). By outputting the determination of the performance of the device 1 (s8), the evaluation processing is ended.

The good or bad of the performance of the device 1 is determined totally on the basis of:
a. in the Step 7, whether or not the amount of deviation between the side beam phase difference on the inner circle side and the side beam phase difference on the outer circle side, which are measured for CD in the step s6, is within a predetermined range,
b. whether or not the amount of deviation between the side beam phase difference on the inner circle side and the side beam phase difference on the outer circle side, which are measured for DVD in the step s6, is within a predetermined range,
c. whether or not the level of the reproducing signal (RF signal) for CD is within a predetermined range, and
d. whether or not the level of the reproducing signal (RF signal) for DVD is within a predetermined range and whether or not the leak-in of LPP is within a predetermined range.

Incidentally, the leak-in of LPP is obtained from a difference in level between DVD reproducing signals (RF signals) measured at the position (first inner DVD evaluation region 22b), which is 45 mm measured from the center of the evaluation disc 20, and at the position (second inner DVD evaluation region 22c), which is 48 mm measured from the center of the evaluation disc 20.

Further, since the depth of the pit for DVD recording information, which is formed in the inner DVD evaluation region 21b and the outer DVD evaluation region 23b, is λ/8 and the TE signal having sufficient level can be obtained by the DPP method, it is possible to measure the side beam phase difference precisely.

As descried, since the evaluation disc 20 according to this embodiment includes the CD evaluation regions 21a, 22a and 23a in which the CD standard recording information are formed and the DVD evaluation regions 21b, 22b and 23b in which the DVD standard recording information are formed in the inner circular region 21, the intermediate circular region 22 and the outer circular region 23, respectively, it is possible to measure the side beam phase differences for CD and DVD on the inner, intermediate and outer circular sides there of. Therefore, it is possible to make the optical disc device 1, which is capable of performing the recording/reproducing operation for both optical CD and DVD, to appropriately measure the test items for CD and DVD to thereby perform the evaluation of performance of the optical disc device 1 on the basis of the test results. In addition, it is possible to perform the evaluation related to the leak-in of the land pre-pit (LPP) in the reproducing signal.

Incidentally, in addition to the test items to be measured by using the evaluation disc 20, other test items may be added.

What is claimed is:

1. An evaluation disc for use in evaluating a pickup head of an optical disc device, comprising:
an inner circular region including: an inner CD evaluation region written with CD standard recording information; and an inner DVD evaluation region written with DVD standard recording information;
an intermediate circular region including: an intermediate CD evaluation region written with the CD standard recording information; an intermediate DVD evaluation region written with the DVD standard recording information; and a land pre-pit region formed with a land pre-pit; and
an outer circular region including: an outer CD evaluation region written with the CD standard recording information; and an outer DVD evaluation region written with the DVD standard recording information, wherein:
the outer circular region and the intermediate circular region are formed on the outer side of the inner circular region;
the outer circular region is formed on the outer side of the intermediate circular region;
at least one of the inner DVD evaluation region, the intermediate DVD evaluation region, and the outer DVD evaluation region has a pit different in depth than that of the other of the inner DVD evaluation region, the intermediate DVD evaluation region, and the outer DVD evaluation region.

2. An evaluation disc for use in evaluating a pickup head of an optical disc device, comprising:
an inner circular region:
an intermediate circular region; and
an outer circular region; wherein
the outer circular region and the intermediate circular region are formed on the outer side of the inner circular region;
the outer circular region is formed on the outer side of the intermediate circular region;
each of the inner circular region, the intermediate circular region and the outer circular region being divided in to a CD evaluation region written with CD standard recording information and a DVD evaluation region written with DVD standard recording information.

3. The evaluation disc according to claim 2, wherein
at least one of the DVD evaluation regions includes a land pre-pit region formed with a land pre-pit.

4. The evaluation disc according to claim 2, wherein
at least one of the DVD evaluation regions has a pit different in depth than that of the other of the DVD evaluation regions.
